(19) United States
(12) Patent Application Publication
(10) Pub. No.: US 2009/0106423 A1
(43) Pub. Date: Apr. 23, 2009

(54) Providing Services Via A Communication System

(75) Inventor: Jukka-Pekka Salmenkaita, Helsinki (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/791,528

(22) PCT Filed: Nov. 25, 2004
(86) PCT No.: PCT/FI04/00716

§ 371 Date: Oct. 26, 2007

(51) Int. Cl. G06F 15/173

(52) U.S. Cl. 709/226

(57) ABSTRACT

A method provides services via a communication system. The method comprises comparing an identifier relating to a removable storage means to information on at least one set, wherein each set is related to at least one identifier. The method further comprises fetching at least one feature determined for said at least one set, when the comparing shows that said identifier belongs to said at least one set. Furthermore, the method comprises providing a communication device equipped with the removable storage means with a service in association with said at least one feature. A computer program, removable storage means, communication device and a network element are configured to execute the method.

### FIELD OF THE INVENTION

The invention relates to communication systems, and more particularly to providing services via a communication system.

### BACKGROUND OF THE INVENTION

A communication system can be seen as a facility that enables communication sessions between two or more entities such as a communication device and/or other nodes associated with the communication system. Wireless communication systems include various cellular or otherwise mobile communication systems using radio frequencies for sending voice or data between stations, for example between a communication device and a transceiver network element. Examples of wireless communication systems may comprise public land mobile network (PLMN), such as global system for mobile communications (GSM), general packet radio service (GPRS) and universal mobile telecommunications system (UMTS). Further examples of wireless communication systems may comprise wireless local area network (WLAN), wireless packet switched data networks, such as a wireless Internet Protocol (IP) network and so on. Wireless communication systems may be connected to other wireless communication systems or wired communication systems, such as a public switched telephone network (PSTN). Various communication systems may simultaneously be concerned in a connection.

A user of a wireless communication device may access a communication network via a radio access network (RAN) comprising transceiver network elements, such as Node B or base transceiver station (BTS), and typically controlled by an appropriate controller network element, such as radio network controller (RNC) or base station controller (BSC). Examples of radio access networks may comprise the UMTS terrestrial radio access network (UTRAN) and the GSM/EDGE radio access network (GERAN).

Examples of communication devices may comprise, but are not limited to, user equipment (UE), a mobile station (MS), a cellular phone, a personal digital assistant (PDA) and a laptop computer. Further examples may comprise any other equipment operable according to a suitable network or transport protocol, such as a Session Initiation Protocol (SIP), a Real-Time Transmission Protocol (RTP), a File Delivery over Unidirectional Transport (FLUTE), a wireless applications protocol (WAP) or a hypertext transfer protocol (HTTP).

Portable communication devices may need to store or contain a lot of data. Storage capacities of the devices are growing and may include, for example, swappable memory cards and microdrives. In many cases, for example in imaging applications, the data may have to be manageable by a user, often in connection with service usage. For example, users might share content directly from one device to another device, or via a web server providing a suitable service.

It may be desired to provide system and methods for bundling services to properties of physical memory peripherals of a communication device. This may make finding, paying for, activating, and using services more tangible than accessing the services using some general application like a web browser.

Patent Application EP 0 955 613 A2 relates to an integrated circuit card storing purchase history information. A customer may be provided with premiums, such as discounts, using such a card.

Patent Application US2003/0133572 A1 relates to a removable security module, which can be inserted into a television set-top terminal to permit reception of services from a system operator.

Patent Application WO 03/101000 A1 relates to a removable storage unit for a mobile unit. The removable storage unit can contain an IP address of a user.

### SUMMARY OF THE INVENTION

In accordance with an aspect of the invention, there is provided a method for providing services via a communication system. The method comprises comparing an identifier relating to a removable storage means to information on at least one set, wherein each set is related to at least one identifier. The method further comprises fetching at least one feature determined for said at least one set, when the comparing shows that said identifier belongs to said at least one set. The method further comprises providing a communication device equipped with the removable storage means with a service in association with said at least one feature.

In accordance with a further aspect of the invention, there is provided a computer program comprising program code means for performing any of the steps according to the method when the program is run on a computing means.

In accordance with a further aspect of the invention, there is provided a removable storage means for a communication device. The removable storage means comprises an identifier and an activator for activating at least one feature determined to relate to the identifier for providing a communication device equipped with the removable storage means with a service in association with the at least one feature.

In accordance with a further aspect of the invention, there is provided a communication device configured to function with a removable storage means. The removable storage means comprises an identifier and an activator for activating at least one feature determined to relate to the identifier for providing the communication device with a service in association with the at least one feature.

In accordance with a further aspect of the invention, there is provided a communication device. The communication device is configured to request for a service. The communication device is further configured to provide an identifier, the identifier relating to a removable storage means associated with the communication device, wherein at least one feature is determined for a set comprising said identifier. The communication device is further configured to receive the service in association with said at least one feature.

In accordance with a further aspect of the invention, there is provided a network element in a communication system. The network element is configured to receive a request for a service. The network element is further configured to compare an identifier, the identifier relating to a removable storage means associated with a communication device requesting the service, to information on at least one set, wherein each set is related to at least one identifier. The network element is further configured to fetch at least one feature determined for said at least one set, when the comparing shows that said identifier belongs to said at least one set. The network element is further configured provide a communication device equipped with the removable storage means with a service in association with said at least one feature.

In an embodiment, the identifier may be a unique identifier relating to at least one of a variety of memory card types and microdrives. In an embodiment, the at least one feature may be defined based on a hierarchical information relating to the at least one set. In an embodiment, said at least one feature may be activated or allowed to be activated when providing the service.

In an embodiment, said at least one feature may comprise access rights to the service. In an embodiment, said at least one feature may comprise at least one feature determined by accessing a server via the communication system.

In an embodiment, said at least one feature may be provided in at least one plug-in software module adding functionality to software present in the communication device. In an embodiment, said at least one feature may be provided in at least one plug-in software module allowing a use of a certain function of software present in the communication device. In an embodiment, the at least one plug-in software module may be fetched from a network via the communication system. In an embodiment, the at least one plug-in software module may be updated from a network via the communication system. In an embodiment, said at least one feature may be provided in at least one software package stored in the removable memory.

In an embodiment, the removable memory may be registered to be associated with said communication device. In an embodiment, information on registering may be stored in the communication device, said information may be stored in the removable memory or said information may be transferred in a network server.

In an embodiment, the service may be provided through at least one of a control framework and a media manager application running in the communication device.

In an embodiment, the service is an imaging service.

### BRIEF DESCRIPTION OF THE DRAWINGS

The invention will now be described in further detail, by way of example only, with reference to the following examples and accompanying drawings, in which:

FIG. 1 shows an example of a system in which the embodiments of the invention may be implemented;

FIG. 2 shows a communication device according to an embodiment of the invention; and

FIG. 3 shows a flow chart of an embodiment of the invention.

### DETAILED DESCRIPTION OF PREFERRED EMBODIMENTS

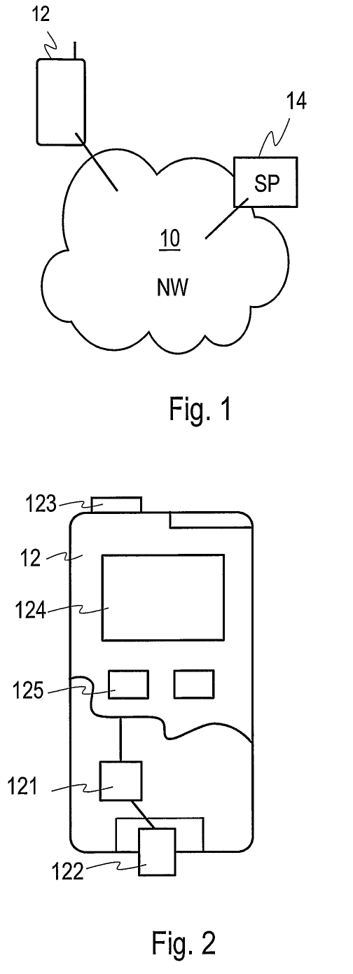

FIG. 1 shows an example of a communication system in which the embodiments of the invention may be implemented. FIG. 1 shows a communication network (NW) 10, a communication device 12 and a server of a service provider (SP) 14.

The communication network 10 may comprise one or more networks. In an embodiment, the communication device 12 may access the communication network 10 via an access network or an access link (not shown). Examples of possible access networks and access links may comprise, but are not limited to a cellular network, e.g. a GPRS network, a wireless local area network (WLAN), Bluetooth connection and so on. The communication network 10 may be provided at least in part by means of an IP network, such as the Internet.

It shall be appreciated that, although for clarity reasons FIG. 1 shows only one communication device, one server of a service provider and one communication network, a typical communication network system usually includes a number of these entities. Depending on the communication system, the terminology used in connection with entities having similar function may also vary.

FIG. 2 shows an exemplifying communication device 12. The communication device 12 may be a mobile device capable of running an imaging application and a media manager application, for example by means of a processor 121 of the device. The communication device 12 may comprise service access capabilities for accessing imaging-related services via a communication network. Furthermore, the communication device 12 is configured to function with a removable storage means 122, such as memory cards or microdrives, also called a removable memory. The communication device 12 further comprises connectivity means, for example comprising a radio transmitting and receiving means, such as an antenna 123. Synchronization technology utilizing the connectivity means may also be provided. Furthermore, the communication device 12 may comprise a display 124 for displaying data, such as data relating to the imaging service. Operation of the communication device 12 may be controlled by an appropriate control interface, such as control buttons 125, a rotating control disk or a touch sensitive display.

FIG. 2 shows only one exemplifying communication device in which the embodiments of the invention may be implemented. It shall be appreciated that the type of the communication device may differ substantially from what is shown in FIG. 2. The radio reception and transmission means may as well be built in the casing of the communication device or arranged in another appropriate manner. The control buttons of any appropriate form may be positioned in an appropriate manner depending on the communication device type, size and use, for example. The communication device may further comprise fixed memory means, as well as other appropriate features, such as camera means, speaker means, and so on.

The communication device is capable of using services, such as imaging-related services, via a communication network. In an embodiment, services may be provided in the Internet. In an embodiment, services may be used through a control framework embedded in an appropriate location in the communication device. For example, the control framework may be embedded in an image gallery application of the communication device. In an alternative, the control framework may be embedded in another application in the communication device usable through a standard Application Programming Interface (API) of the communication device. The control framework may enable functioning in accordance with requirements of the communication device and/or settings of the user. At the same time, the control framework may enable service providers to provide their services in accordance with requirements and/or settings of each service provider. The control framework may consist of a plurality of functionalities with APIs, through which functionalities of the communication device may be accessed. Such functionalities may include, but are not limited to, an application interworking interface in the communication device, connectivity software components, other applications, such as media manager application, camera client, multimedia messaging service (MMS) client and so on. The media manager application, such as a so-called Personal Media Manager application, may combine different aspects of the invention together.

The removable storage means 122 may comprise memory cards. The cards are preferably hot-swappable (i.e. the device can be on when the card is changed), and they can be of any of the specific memory card types like multimedia memory cards (MMC), secure digital (SD) cards, mini-SDs, reduced size MMCs (RS-MMCs), xD picture cards, Sony Memory Sticks, and so on. Furthermore, removable storage means may comprise microdrives or other such removable memory means.

A unique identifier identifies a removable memory. The unique identifier is an identification means that cannot be manipulated, for example, by an end-user or by means of software. The unique identifier may relate to a specific means, such as a specific card, for example an identification (ID) number, or to a larger manufacturing series of a type of the memory means, such as a card type, for example a serial number. For example, an MMC may have a so-called card identification (CID) register, which may comprise manufacturer ID, application ID, product name, product revision, product serial number and manufacturing date. The CID may provide the unique identifier to be used in embodiments of the invention.

In embodiments of the invention, a range of unique identifiers may be reserved for a predetermined service or a predetermined service level. A reserved range may comprise one or more unique identifiers. One or more reserved ranges may be defined among a plurality of unique identifiers. Each range may be named or labelled in an appropriate manner. For example, the removable memories provided with a unique identifier belonging to a first range may be named as “Nokia platinum cards” or the like, the removable memories provided with a unique identifier belonging to a second range may be named as “Nokia gold cards” or the like, the removable memories provided with a unique identifier belonging to a third range may be named as “Nokia silver cards” or the like, and so on. Any appropriate naming or labelling system may be used.

A removable memory 122 may be used in the communication device 12 in connection with a service, such as an imaging service. An application, such as a media manager application, in the device 12 may determine if the unique identifier of the removable memory 122 belongs to at least one reserved range. If the application determines that the unique identifier belongs to at least one reserved range, the application may allow activation or activate feature or features of the service reserved to said at least one reserved range.

In an embodiment, the removable memory 122 is provided with an activator, which activates or allows activation of at least one feature, which at least one feature relates to the identifier of the removable memory 122. Said activation launches provision of the service together with or using the at least one feature. Thus, the service is provided in association with an additional feature or features, which depend on the identifier of the removable memory 122. In an embodiment, the activator may be the at least one feature or a part of the at least feature. In another embodiment, the activator may be a separate attribute, such as a piece of software stored in the removable memory 122, which separate attribute is not provided in association with the at least one feature and the service.

In an embodiment, said features, which may be activated, may comprise access rights to a service. For example, it may be defined that only a unique identifier belonging to the first range has access rights to a particular service, such as a particular network storage service. Said service may be accessible, for example, using the control framework embedded in the communication device 12. An example of practical benefits of this embodiment for a user is that only the memory card belonging to a reserved range, e.g. “Nokia platinum” card class, needs to be purchased and the services related to that reserved range can then be automatically discovered, configured, and taken into use without requiring further monetary transactions by the user.

In an embodiment, said features, which may be activated, may comprise features determined by accessing a server. In this embodiment, said features may be dynamically changed, updated or otherwise manipulated. This may provide flexibility to the system. For example, the media manager application could determine, based on the card ID, that the card and/or a user of the card is entitled to a back-up service on the network for the contents of the card. However, the Internet access specific for the back-up service could vary over time, or based on the operator of the user, or the amount of backup space provided might change over time. For these kinds of flexibility issues, it can be advantageous that the media manager application can contact a server, which then provides more detailed service parameters, e.g. a storage server address and configuration details. This may take place once, for example the first time when the card is taken into a use, or periodically. In an embodiment, the media manager can have more complex rules on when to check the service parameters.

In an embodiment, said features, which may be activated, may comprise plug-in software modules. In this embodiment, a plug-in software module may add functionality to a basic application or software present in the communication device 12 or allow a use of a certain function of the basic application or software present in the communication device 12. In an embodiment, plug-in software modules may be updated or fetched from a network when and as appropriate. In a further embodiment, plug-in software modules may be software packages stored and delivered in the removable memory 122. The software packages may be installed into the communication device 12 when the functionality is first activated. In an alternative, the software packages may be installed into the communication device 12 anytime before the functionality is first activated.

In an embodiment, when the removable memory is used for the first time, the removable memory may be registered to be associated with a particular communication device. This information may be stored in the communication device, in the removable memory or transferred in a network server. In an embodiment, once registered to be associated with the particular communication device said features might be available for an end-user of the particular communication device without further activating or registration. In an embodiment, the features can be made available when the user has changed the memory card. In particular with hot-swappable memory cards the user may change the memory cards often.

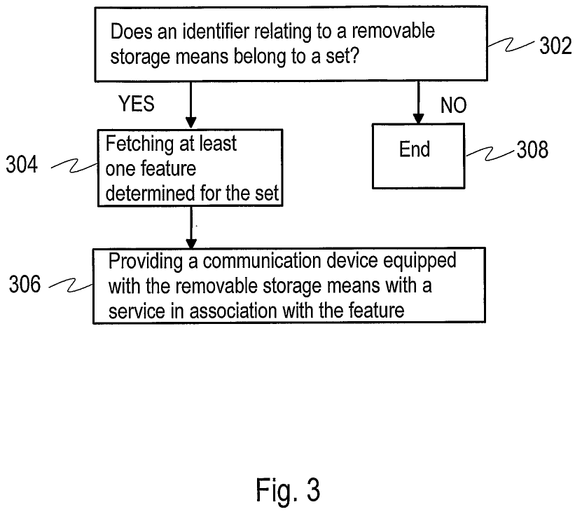

FIG. 3 shows a flow chart illustrating an embodiment of the invention. In step 302, an identifier relating to a removable storage means is compared to information on at least one set, wherein each set is related to at least one identifier. When the comparing shows that said identifier belongs to said at least one set, at least one feature determined for said at least one set is identified and/or fetched in step 304. In step 306, a communication device equipped with the removable storage means is provided with a service in association with said at least one feature. When the comparing shows that said identifier does not belong to any of said at least one set, no service is provided as shown in step 308.

Embodiments of the invention may enable offering or making available various features, functions and services. An example may comprise a secure network storage and/or backup service. The storage and/or backup service may be defined for an amount of content that may be smaller, equal or greater than the amount of storage capacity of the removable memory. Examples may further comprise sharing or publishing service. Examples may further comprise special algorithms useful for manipulating personal content, such as red-eye reduction in relation to imaging services. Furthermore, plug-in software modules may extend functionality of the media manager application, such as by replacement of regular slideshow with new slideshows including background music and transition effects, for example based on a hit movie or the like. In an embodiment, the plug-in modules could utilize content that is delivered in the same memory card, for example background music alternatives and movie transition effects. In an embodiment, the plug-in modules may comprise complete application plug-ins extending a feature set of the media manager application. The plug-ins can also be service specific extensions to the media manager application. The plug-ins may thus be applications that can be launched from the media manager application and allow service usage related to the personal content selected based on features defined for an identifier range relating to the memory card in question

Although the invention has been described in the context of particular embodiments, various modifications are possible without departing from the scope and spirit of the invention as defined by the appended claims. It should be appreciated that whilst embodiments of the present invention have mainly been described in relation to mobile communication devices such as mobile terminals, embodiments of the present invention may be applicable to other types of communication devices. Furthermore, the communication system may be any appropriate communication system, even if reference has mainly been made to mobile communication systems.

1. A method for providing services via a communication system, the method comprising:
comparing an identifier relating to a removable storage means to information on at least one set, wherein each set is related to at least one identifier;
fetching at least one feature determined for said at least one set, when the comparing shows that said identifier belongs to said at least one set; and
providing a communication device equipped with the removable storage means with a service in association with said at least one feature.

2. The method according to claim 1, wherein the step of comparing comprises comparing a unique identifier relating to at least one of a variety of memory types and microdrives.

3. The method according to claim 1, wherein the step of fetching comprises fetching at least one feature, wherein the at least one feature is defined based on a hierarchical information relating to the at least one set.

4. The method according to claim 1, wherein the step of providing comprises at least one of activating and allowing activation of said at least one feature.

5. The method according to claim 1, wherein the step of fetching comprises fetching said at least one feature, said at least one feature comprising access rights to the service.

6. The method according to claim 1, wherein the step of fetching comprises fetching said at least one feature, said at least one feature comprising at least one feature determined by accessing a server via the communication system.

7. A method according to claim 1, wherein the step of fetching comprises fetching said at least one feature provided in at least one plug-in software module adding functionality to software present in the communication device.

8. A method according to claim 1, wherein the step of fetching comprises fetching said at least one feature provided in at least one plug-in software module allowing a use of a certain function of software present in the communication device.

9. A method according to claim 7, wherein the step of fetching comprises fetching the at least one plug-in software module from a network via the communication system.

10. A method according to claim 7, further comprising updating the at least one plug-in software module from a network via the communication system.

11. A method according to claim 7, wherein the step of fetching comprises fetching said at least one feature provided in at least one software package stored in the removable memory.

12. A method according to claim 1, wherein the step of comparing comprises registering the removable memory to be associated with said communication device.

13. A method according to claim 12, wherein the step of registering comprises at least one of storing information on registering in the communication device, storing said information in the removable memory and transferring said information in a network server.

14. A method according to claim 1, wherein the step of providing comprises providing the service through at least one of a control framework and a media manager application running in the communication device.

15. A method according to claim 1, wherein the step of providing comprises providing an imaging service.

16. A computer program comprising program code means for performing any of the steps according to claim 1 when the program is run on a computing means.

17. A removable storage means for a communication device, the removable storage means comprising:
an identifier; and
an activator for activating at least one feature determined to relate to the identifier for providing a communication device equipped with the removable storage means with a service in association with the at least one feature.

18. A communication device configured to function with a removable storage means, the removable storage means comprising:
an identifier; and
an activator for activating at least one feature determined to relate to the identifier for providing the communication device with a service in association with the at least one feature.

19. A communication device for a communication system, the communication device configured to:
request for a service;
provide an identifier, the identifier relating to a removable storage means associated with the communication device, wherein at least one feature is determined for a set comprising said identifier; and
receive the service in association with said at least one feature.

20. A communication device for a communication system, the communication device comprising:
requesting means for requesting for a service;
providing means for providing an identifier, the identifier relating to a removable storage means associated with the communication device, wherein at least one feature is determined for a set comprising said identifier; and
receiving means for receiving the service in association with said at least one feature.

21. A communication device for a communication system, the communication device comprising:
a transmitter for requesting for a service;
a removable storage means for providing an identifier, the identifier relating to the removable storage means, wherein at least one feature is determined for a set comprising said identifier; and
a receiver for receiving the service in association with said at least one feature.

22. A network element in a communication system, the network element configured to:
receive a request for a service;
compare an identifier, the identifier relating to a removable storage means associated with a communication device requesting the service, to information on at least one set, wherein each set is related to at least one identifier;
fetch at least one feature determined for said at least one set, when the comparing shows that said identifier belongs to said at least one set; and
provide a communication device equipped with the removable storage means with a service in association with said at least one feature.

23. A network element in a communication system, the network element comprising:
receiving means for receiving a request for a service;
comparing means for comparing an identifier, the identifier relating to a removable storage means associated with a communication device requesting the service, to information on at least one set, wherein each set is related to at least one identifier;
fetching means for fetching at least one feature determined for said at least one set, when the comparing shows that said identifier belongs to said at least one set; and
providing means for providing a communication device equipped with the removable storage means with a service in association with said at least one feature.

24. A network element in a communication system, the network element comprising:
a receiver for receiving a request for a service;
a comparator for comparing an identifier, the identifier relating to a removable storage means associated with a communication device requesting the service, to information on at least one set, wherein each set is related to at least one identifier;
a fetcher for fetching at least one feature determined for said at least one set, when the comparing shows that said identifier belongs to said at least one set; and
a transmitter for providing a communication device equipped with the removable storage means with a service in association with said at least one feature.
